(19) United States
(12) Patent Application Publication
(10) Pub. No.: US 2003/0006998 A1
(43) Pub. Date: Jan. 9, 2003

(54) Portable data entry device with host PDA

(76) Inventor: Rajendra Kumar, Akron, OH (US)

Correspondence Address: Scott M. Oldham, Hahn Loeser & Parks, Twin Oaks Estate, 1225 West Market Street, Akron, OH, 44313, US

(21) Appl. No.: 10/159,296

(22) Filed: May 29, 2002

Related U.S. Application Data
(60) Provisional application No. 60/294,364, filed on May 30, 2001.

(51) Int. Cl. G09G 5/00

(52) U.S. Cl. 345/700

(57) ABSTRACT

It is an object of the invention to provide a device that can adapt off-the-shelf PDA devices to portable data entry applications. The resulting devices must be sized and shaped to be selectively rugged and/or to facilitate handheld operation when the user is mobile during use. The device provides features required for portable data entry such as key entry, barcode scanning, and wireless local area network communications.

### TECHNICAL FIELD

The invention relates to a portable data entry device which allows a host PDA to be selectively coupled therewith for use in portable data entry applications, wherein the host PDA provides processing capabilities in conjunction with the device.

### BACKGROUND

Portable data entry devices are known for use in the bar code industry as an example, wherein bar code scanners and key-entry based hand held computers are used for applications such as inventory tracking, in store order entry, package delivery, route sales or the like. Various dedicated products have been developed for this purpose, such products including a bar code scanning system, a data processing system, and communications features. Although such devices provide desired attributes of portability along with data capture and communication capabilities, the devices are expensive and relatively inflexible in their operation.

There have also been developed personal electronic organizers and personal digital assistant (PDA) devices. PDA devices are handheld devices with pen input means and personal information management (PIM) software such as to-do lists, contact lists, and appointments.

Compared with portable data entry devices, PDA devices have the benefit of the economies of scale. Therefore PDA devices are less expensive, more compact, and offer higher performance in several areas by employing new technologies at a faster pace. Consequently, it would be advantageous to employ PDA devices for portable data entry applications. However, PDA devices lack several key features essential to many of the portable data entry applications such as barcode scanners, keyboards with numeric and/or alphabetic characters, and wireless local area network (LAN) radios. Another key feature missing in the PDA devices is ruggedness, which is essential when the user is mobile during the use of the device. (In contrast, the users of PDA devices are stationary during the actual use of the device). Additionally, PDA devices are not configured with a form factor to allow simple portable data entry in the variety of different environments in which portable data entry devices are used.

Some manufacturers of the barcode industry have attempted to solve these problems by licensing the internal electronic assemblies of the PDA devices from their suppliers and packaging them with portable data entry features in custom designed cases. Examples of such products are models SPT-1500 and SPT-1700 from Symbol Technologies of Holtsville, N.Y. However, this process is time consuming and requires expensive re-engineering, which has to be repeated with introduction of each new PDA. Also, since the resulting devices are produced in smaller volumes, significant benefits of using the PDA technology are lost.

Some manufacturers have provided devices for adding peripheral functions to PDA devices. One example of such a cradle is model 6016 Handheld Printer from Monarch division of Paxar Corporation of White Plains, N.Y. Another example of a device is the Card Expansion Pak unit provided by Compaq Computer Corporation of Houston, Tex. for its iPAQ Pocket PC units. Although these products do a good job of adding a special feature to the PDA such as printing and card slots, they fail to make the PDA devices suitable for portable data entry because they do not provide keyboard, ruggedness, size, and shape to facilitate handheld operation when the user is mobile during the use of the device.

### SUMMARY

It is therefore an object of the current invention to provide a device that can adapt off-the-shelf PDA devices to portable data entry applications. The resulting devices must be sized and shaped to be selectively rugged and/or to facilitate handheld operation when the user is mobile during use. The device provides features required for portable data entry such as key entry, barcode scanning, and wireless local area network communications.

The current invention is a portable data entry device for keyboard and barcode based data entry consisting of a personal digital assistant (PDA) device with an input-output connector and a handheld cradle unit. The cradle unit includes a user interface, such as a keyboard with keys for numeric entry and/or a group of keys for alphabetic entry. The cradle unit also comprises a cavity that is formed to accept the said PDA device to dock into it. A docking connector is located in the cavity and mates with the input-output connector of the PDA device when the said PDA device is docked into the cavity. The handheld cradle unit includes an interface circuit that connects the docking connector to at least one of the components of the handheld cradle unit and puts it in control of the said PDA unit when the PDA unit is docked into the handheld cradle unit.

There is a housing that carries the components of the handheld cradle unit. The housing is preferably sized and shaped to facilitate handheld operation when the user is mobile during the use of the device. The housing may encase the PDA unit when docked so as to protect the PDA unit against damage during use in harsh environments.

The above-described device may also include a scanner for reading barcodes and a wireless radio module for wireless communication.

The handheld cradle unit may be equipped with a handle-grip to facilitate gun-styled scanning. The handle-grip can be equipped with a trigger switch for barcode scanning. Alternately, the handheld cradle unit may have a reduced circumference at the keypad area to allow a comfortable grip of the device in one hand during use. The hand held cradle unit may also be configured to allow operational coupling between off-the-shelf PDA devices which may have different dimensional characteristics. In an embodiment, the housing provides a cavity in which a PDA device mates with the input-output connector, while allowing various width PDA devices to be accommodated therein. The form of the housing also facilitates coupling of a PDA device thereto for use, with the resulting overall configuration being small and configured to facilitate handheld operation.

The device may also include an auxiliary battery in order to provide power to the circuit contained in the handheld cradle unit and optionally, to increase the operating life of the combined unit in between charges.

These and other objects and advantages of the invention will become apparent upon a reading of the detailed description relating to various embodiments of the device according to the invention in conjunction with the drawings.

### BRIEF DESCRIPTION OF THE DRAWINGS

FIG. 1 is an exploded view of an embodiment of the device according to the invention.

FIG. 2 is a top view of the device as shown in FIG. 1.

FIG. 3 is a side view of the device as shown in FIG. 1.

FIG. 4 is a front view of the device as shown in FIG. 1.

FIG. 5 is a bottom view of the device as shown in FIG. 1.

FIG. 6 is a cross sectional view taken along line A-A of FIG. 5, showing internal components of the device.

FIG. 7 is a schematic diagram of the electrical components associated with the device, such as shown in FIG. 1.

FIG. 8 is an exploded view of an alternate embodiment of the device according to the invention.

FIG. 9 is a front view of the device as shown in FIG. 8.

FIG. 10 is a side view of the device as shown in FIG. 8.

FIG. 11 is a cross sectional view of the device taken along line 11-11 in FIG. 9.

FIG. 12 is a front view of an alternate embodiment of a device according to the invention.

FIG. 13 is a side view of the embodiment as shown in FIG. 12.

### DETAILED DESCRIPTION OF THE INVENTION

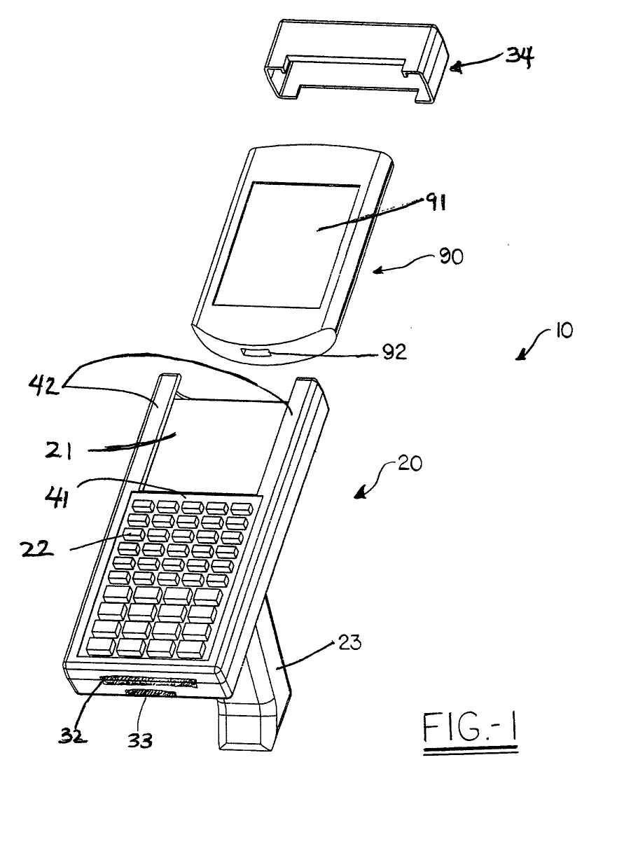

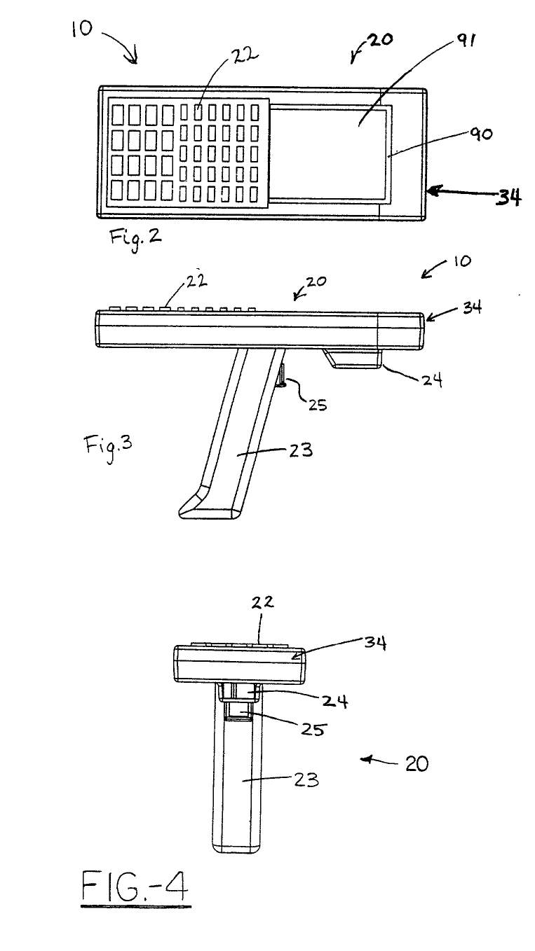

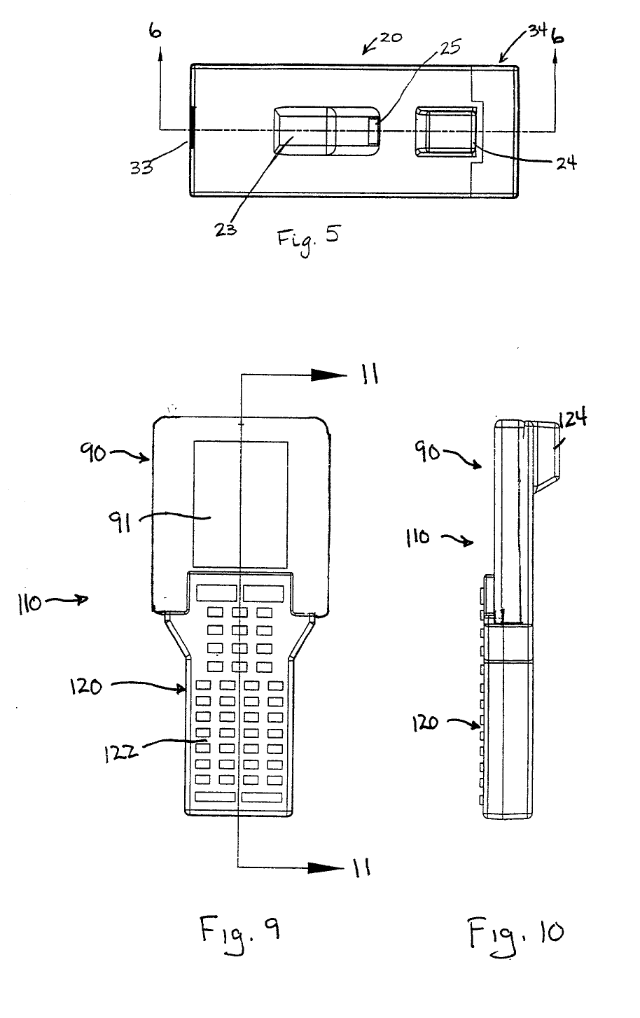

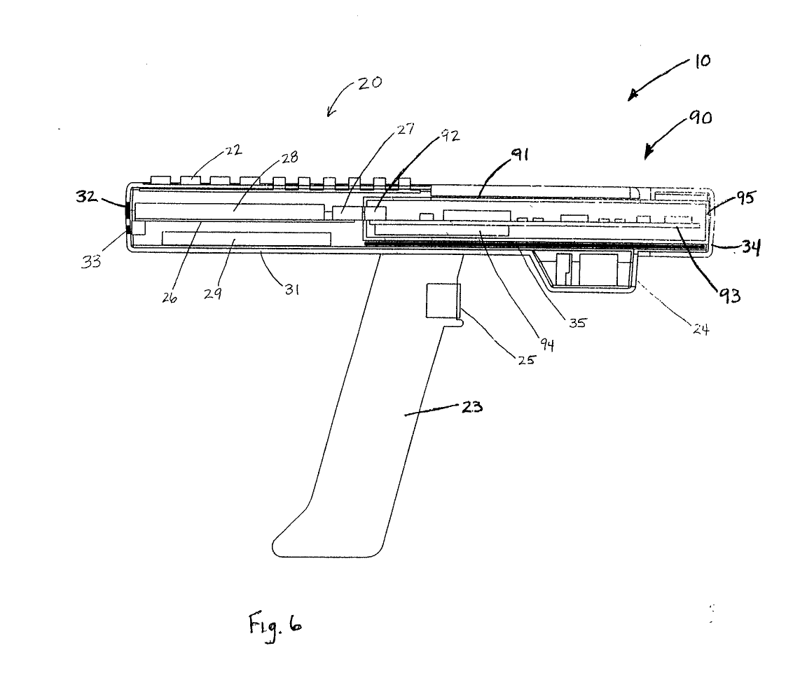

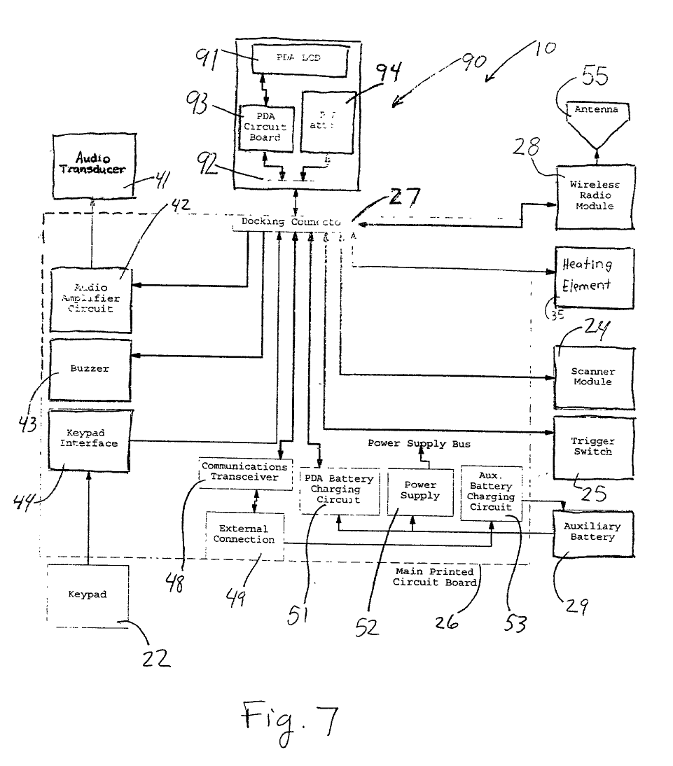

Turning now to a first embodiment according to the invention, FIGS. 1-7 refer to a first exemplary embodiment, wherein a portable data entry device 10 includes a cradle unit 20, to which is selectively coupled an off-the-shelf PDA unit 90. The PDA unit 90 includes a display 91, on the front, and a docking connection 92 on the bottom end. The cross-sectional view of FIG. 7 shows an internal printed circuit board with attached circuitry 93, the internal battery 94 of the PDA, and the external case 95 of the PDA. Cradle unit 20 comprises a cavity 21, keypad 22, and optional handle 23. A scanning module 24 (such as those produced by Welch-Allyn and Symbol), works in coordination with a trigger switch 25 mounted on the handle 23. PDA unit 90 is inserted into the cavity 21 of cradle unit 20. Optional end cap 34 protects the PDA 90 from damage in a portable data entry environment. The cradle design is such that at least the active portion of display 91 of the PDA 90 is clearly visible when the PDA 90 is fully docked in the cavity 21. Any subsection of the external case 95 that resides below the screen 91 in the facing front view may be covered over by the cradle unit keypad 22. In one operational mode, once PDA 90 is fully docked in the cavity 21, the operational switches or other actuators of the PDA unit 90 are covered and rendered inoperational. Alternatively, the cradle unit 20 could be configured to allow access to these actuators if desired. Associated with the cradle unit 20, a wireless communication module or other operational module 28 (shown in FIG. 6) may be provided. The module 28 may further be configured to be insertable through a module opening 32. The opening 32 allows for the user to insert, remove, or replace wireless modules. An external connector 33 allows for the unit to be charge and for data to flow to a connected PC or other data terminal. The input-output connection 92 of the PDA unit 90 connects to cradle docking connection 27 (ELCO, Molex etc.) when PDA unit 90 is docked into the cavity 21. The cradle docking connection 27 allows operational connection between the PDA unit 90 and the internal circuitry of the cradle unit 20. This operational connection between the cradle unit 20 and the PDA unit 90 allows access to the PDA unit operational characteristics in use with the cradle unit 20. In this manner, the PDA device 90 and its processing capabilities are combined with features of the cradle unit 20 to provide a fully functional portable data entry device having characteristics of custom manufactured devices, but reaping the advantage of the economies of scale provided by the manufacture of PDA devices 90 for other uses. The cradle docking connection 27 fully integrates the PDA unit 90 electronics with that of the cradle unit 20 to provide various desired attributes in the portable data entry device formed by their combination. As noted in FIG. 6, the cradle unit 20 also comprises a main circuit board 26, which will be described in more detail with reference to FIG. 7. Other electronic components, such as the wireless interface module 28, battery 29 and the like, are encased within the cradle unit 20, which may be formed of a hard plastic material or the like to provide desired ruggedness for the environments in which it is to be used.

The block diagram representation of the electrical components of unit 10 according to this embodiment is shown in FIG. 7. PDA unit 90 encloses the input-output connection 92 of the PDA. This connection 92 is attached to the PDA battery 94, and the PDA circuit board 93. The PDA circuit board is in turn connected to the LCD display 91 of unit 90. When unit 90 is fully seated in the cavity 21, the connector 92 is connected to the docking connector 27 of cradle unit 20.

The docking connector 27 of the cradle unit 20 is connected to various electronic components to interface the components with PDA unit 90. As examples, the docking connector 27 may connect to the audio amplifier 42, which is connected to the audio transducer 41. The audio amplifier circuit 42 and connected audio transducer 41 may be provided to alert the user as to when a proper reading has been obtained by the potable data entry device as an example. Alternatively, wireless audio communication may be provided by the wireless module 28 through the audio circuit. The docking connector may also be connected to the buzzer 43, and the keypad interface 44. The keyboard interface is connected to the keypad 22. The scanner module 24 and trigger switch 25 also interface to the PDA 90 via the docking connector 27. Through the docking connector 27, the PDA also interacts with the communication transceiver 48. This transceiver offers a means to communicate outside of the cradle unit 20 via the external connection 49.

The external connection 49 allows for a standard connection to a PC, or other data-gathering terminal. External connection 49 also allows for the charging of the cradle battery 29. The battery charging is performed via the battery charging circuit 53. The battery 29 may be connected to the cradle power supply 52, and the abovementioned PDA battery charging circuit 51. In this manner, for use as a portable data entry device, the cradle unit 20 may be connected to an external power supply via the external connection 49 to provide recharging of both the cradle battery 29 as well as the PDA battery 94. It should also be recognized that based upon the interconnection between the PDA unit 90 and the power supply 52 of the cradle unit 20, the power supply to either operate components of the cradle unit 20 or PDA unit 90 may be supplied from either battery power source, to facilitate extended operation for use as a portable data entry device.

The block diagram depicts the wireless interface module 28 that is connected to the antenna 55. This wireless module communicates to the PDA device 90 through the docking connector 27. In a variation of the embodiment, the cradle unit 20 may not include wireless interface module 28. In this case, there would either be no wireless interface, or a wireless interface supplied by the PDA unit 90.

Alternatively, the portable data entry device created by the combination of PDA unit 90 with cradle unit 20, may contain one of several variations of the embodiment, in relation to the battery power supplied from the PDA unit 90 and the cradle unit 20. The first variation would be that units 90 and 20 contain their own batteries, and no battery power would be transferred between the two. The second variation would be that the PDA unit 90 would contain the only battery, and this one battery would power both the PDA unit 90 and the handheld cradle unit 20. The third variation would be that the cradle unit 20 would contain the only battery, and this one battery would power both the PDA unit 90 and the cradle unit 20. The fourth variation would have both unit 90 and 20 contain batteries, where unit 90 provides power to and charges the battery in unit 20 where available. The fifth variation would have both unit 90 and 20 contain batteries, were unit 20 provides power to and charges the battery in unit 90 where available.

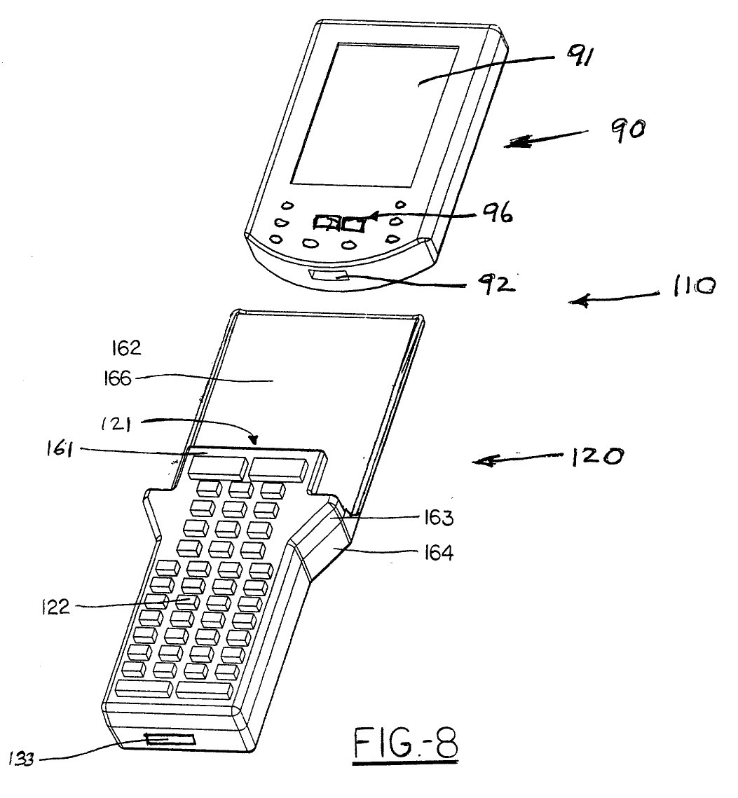

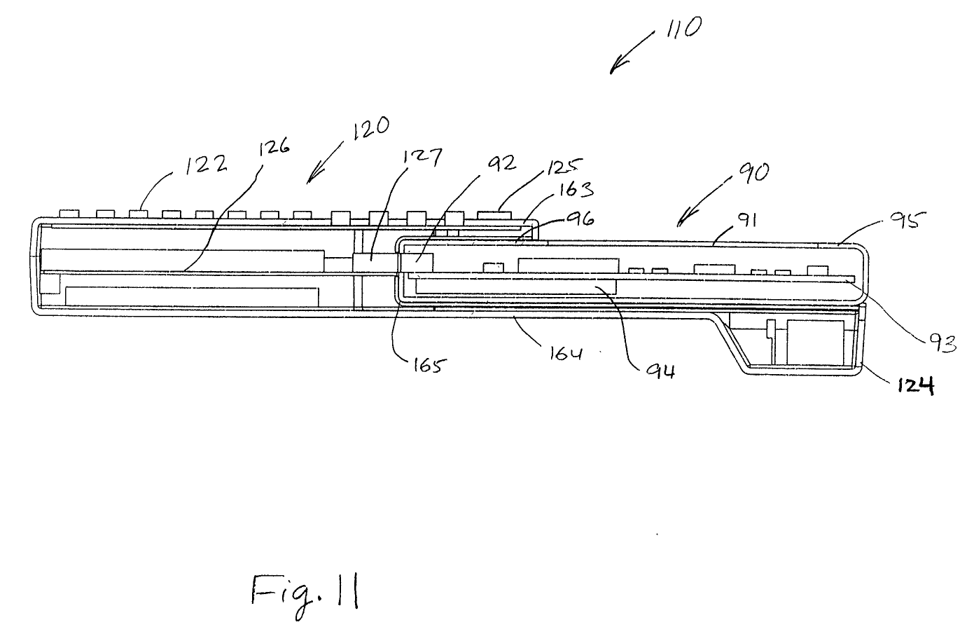

Turning now to FIGS. 8-11, an alternate embodiment of the invention is shown. As in the previous embodiment, the cradle unit identified as 120 provides interconnection to an off-the-shelf PDA unit 90, in a manner similar to that previously described. The PDA unit 90 again comprises a display 91, a docking station 92 and a series of control buttons or the like on a front panel 96. The portable data entry device 110 is formed by interconnection of the PDA unit 90 with the cradle unit 120. In this embodiment, the cradle unit 120 is configured to provide a handheld portable data entry device when combined with PDA unit 90. In this embodiment, the cradle unit 120 provides a small, low profile handheld unit in combination with the PDA unit 90. The cradle unit 120 comprises a keyboard 122, which as shown is formed on a reduced dimension handheld portion of the cradle unit 120, to facilitate grasping with one hand. A cavity 121 is again provided to accept the PDA unit 90 in a docking configuration, but the cavity is preferably open on the outside edges thereof to allow different width PDA units 90 to be accommodated therein. As the dimensions of various PDA units 90 which are manufactured by third party manufacturers can vary, accommodating different dimensional characteristics in the handheld cradle unit 120 provides flexibility in selecting which PDA unit 90 best suits a particular users application.

In this exemplary invention, a portable data entry device can be created, with the added functionality of a removable PDA. When mated in the cradle unit, the PDA unit and its main processor becomes the main controller for the entire portable data entry device.

In this embodiment, the case of the handheld unit 20 may be formed of a front shell 163, back shell 164 and cavity shell 165 or other similar configuration. Within the formed shell of the handheld unit 120, the printed circuit board 126, keypad 122, barcode scanner 124, and other components may be housed to form a rugged handheld portable data entry device. A docking connector 127 is positioned to receive and connect to the PDA device 90 via the output connector 92. The housing of the handheld unit 120 again allows docking of the PDA unit 90 such that the display 91 is unobstructed for viewing of information thereon during use as a portable data entry device.

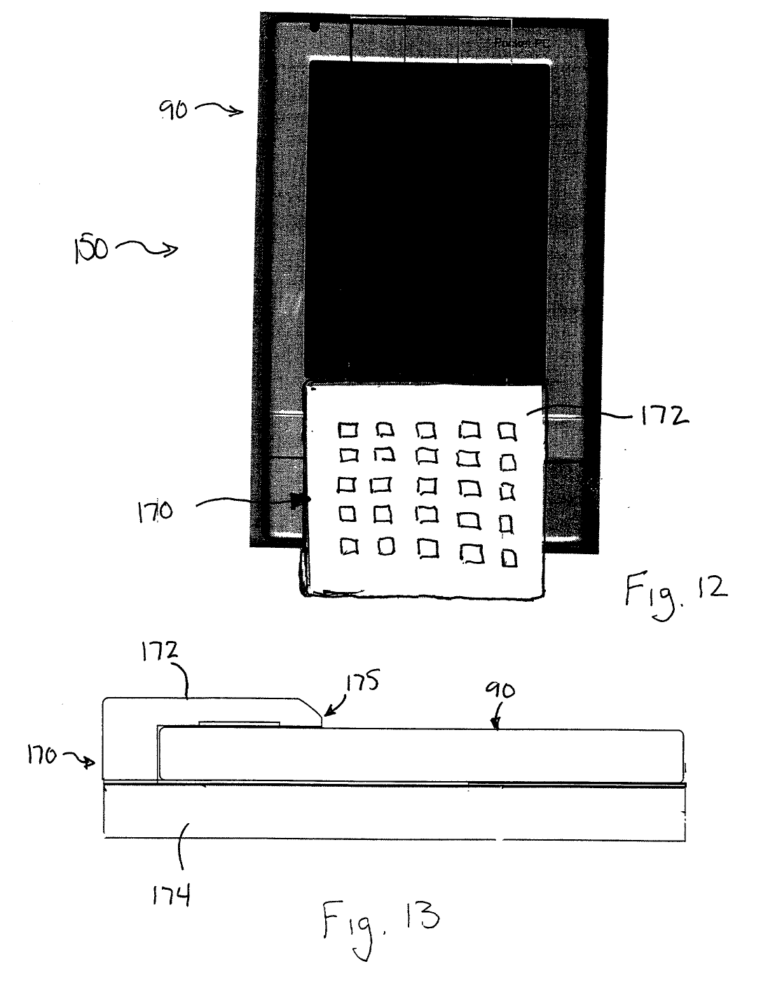

Another embodiment of the invention is shown in FIGS. 12 and 13, wherein a portable entry device 150, including a PDA unit 90 and a handheld cradle unit 170 is provided. In this embodiment, the cradle unit 170 is reduced in size such that it accommodates handheld usage when combined with the PDA unit 90, but is otherwise very small and easily handled. In this embodiment, the handheld cradle unit 170 is configured to have a front shell portion 172, a back shell portion 174 and a cavity 175 to receive the PDA unit 90. Within the handheld cradle unit 170, there may be provided various of the electronic components associated with the embodiments as previously described, including an operator interface such as a keypad, a barcode scanner and the like. The handheld cradle unit 170 provides a unique handheld assembly when PDA unit 90 is docked therewith, which is of extremely low profile and yet facilitates one hand usage as a portable data entry device. The back portion of the handheld cradle unit 170 provides support for the PDA unit 90 and facilitates grasping by the user without requiring handling of the PDA unit 90. The PDA unit 90 is also protected by a front portion of the handheld unit 170 when in its docked position.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. A portable data entry device comprising a personal digital assistant (PDA) device having an input-output connector and a handheld cradle unit, wherein the handheld cradle unit comprises a user interface for the input of data, a docking cavity configured to accept the PDA device in electrical connection with the handheld cradle unit, a connector positioned in association with the cavity to couple with the input-output connector of the PDA device, and an interface circuit connected to the connector to interface with the PDA device and at least the user interface for control of the PDA unit when docked with the handheld cradle unit.

2. The portable data entry device according to claim 1, wherein the handheld cradle unit comprises a housing which carries the components of the handheld cradle unit, the housing being sized and shaped to facilitate handheld operation when the user is mobile during use of the device.

3. The portable data entry device according to claim 2, wherein the housing encases at least a portion of the front and back of the PDA unit when docked so as to protect the PDA unit against damage during use in harsh environments.

4. The portable data entry device according to claim 1, wherein the handheld cradle unit further comprises a barcode scanner.

5. The portable data entry device according to claim 1, wherein the handheld cradle unit further comprises a wireless communication module.

6. The portable data entry device according to claim 1, wherein the handheld cradle unit comprises a housing including a handle-grip to facilitate handheld operation.

7. The portable data entry device according to claim 6, wherein the housing further comprises a trigger switch for actuating a barcode scanner provided with a handheld cradle unit.

8. The portable data entry device according to claim 1, wherein the handheld cradle unit comprises a housing having a front portion, back portion and cavity portion to receive the PDA unit, wherein the front portion encases a portion of the PDA unit when docked therewith, while allowing full visibility of the display associated with the PDA device.

9. The portable data entry device according to claim 8, wherein the front and back portions of the handheld cradle unit encase a portion of the PDA unit when docked therewith without encumbering edge portions of the PDA unit, to facilitate docking of various width PDA units.

10. The portable data entry device according to claim 1, wherein the handheld cradle unit comprises an auxiliary battery.

11. The portable data entry device according to claim 10, wherein the auxiliary battery is selectively coupled to power the PDA unit when docked therewith.

12. The portable data entry device according to claim 1, wherein the handheld cradle unit further comprises a heat source to facilitate heating of components in at least the PDA unit when docked therewith.

13. The portable data entry device according to claim 1, wherein the handheld cradle unit further comprises an external connector for downloading of information stored on the PDA unit when connected therewith, and for recharging of a battery supply associated with the portable data entry device.
